(19) United States
(12) Patent Application Publication
(10) Pub. No.: US 2003/0164245 A1
(43) Pub. Date: Sep. 4, 2003

(54) Stationary induction machine and a cable therefor

(76) Inventor: Claes Areskoug, Ludvika (SE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,740

(22) PCT Filed: Apr. 19, 2001
(86) PCT No.: PCT/SE01/00855

(30) Foreign Application Priority Data
Apr. 28, 2000 (SE) 0001589.1

(51) Int. Cl. H01B 7/00

(52) U.S. Cl. 174/110 R

(57) ABSTRACT

A stationary induction machine including a winding (2) including an elongate, flexible cable (1), having an electric lead (7), and a cooling device, arranged, with the aid of a coolant, to divert excess heat generated in the lead during operation of the induction machine, which lead is in the form of a tube and surrounds a continuous channel (10) for the circulation of said coolant. In accordance with the invention, the cable includes a cooling tube (4) of a polymer material that is arranged in the lead and forms said channel. The invention also relates to a cable for such an induction machine.

### TECHNICAL FIELD

The present invention relates to a stationary induction machine including

at least one winding including at least one elongate, flexible cable having an electric lead, and

a cooling device arranged, with the aid of a coolant, to divert excess heat generated in the lead during operation of the induction machine,

where the lead is in the form of a tube and surrounds a continuous channel for the circulation of said coolant.

The invention also relates to a cable for such an induction machine.

The present invention especially relates to a stationary induction machine, and a cable for such, for system voltages exceeding 1 kilovolt.

In this context, “cable” denotes an electric lead surrounded by a fixed, continuous insulating material.

### BACKGROUND ART

In electric power systems for transmitting electric energy, it is known to use stationary induction machines with windings comprising cables. “Electric power systems” here denotes systems for voltages exceeding 1 kilovolt and “stationary induction machines” here denotes non-rotating induction machines, i.e. transformers and reactors.

A problem with the known cable-wound induction machines, especially in applications where large currents occur, is the difficulty of efficiently diverting the excess heat generated during operation because of Joule-effect losses in the lead of the cable. “Excess heat” here denotes the heat that causes the temperature in the induction machine to exceed a predetermined temperature, which is higher than the ambient temperature. A known method of providing cooling is to create flow paths, in which a coolant is induced to flow, between the winding turns. Usually, the cooling is forced, i.e. the coolant is induced to flow with the aid of a pump or a fan device.

In the cooling arrangement known through WO 98/34239 A1, the winding is designed with spacing elements that separate predetermined adjoining winding turns from each other. Flow paths in which a fan device induces a gas to flow, usually air, are thus created in the winding. In this context, hoods are commonly used to guide the gas stream into the winding. However, the above-mentioned cooling arrangements exhibit a number of drawbacks. First, placing the flow paths between adjoining winding turns means that the winding occupies a relatively large volume. This makes the induction machine relatively large, which in certain applications can be disadvantageous, for instance in transformers where a high filling factor in the winding is desired. The hoods, which guide the air stream into the winding, also contribute significantly to the size of the induction machine and, moreover, make the induction machine expensive to manufacture. Secondly, the flow paths constitute impairments in the winding, as adjoining winding turns separated by a flow path do not support each other. These impairments can make the winding sensitive to the forces that arise during short circuits in the electric power system. Thirdly, the present trend of development is towards ever-higher currents in the induction machines, which requires an ever-higher flow velocity for the coolant in gas-cooled induction machines to provide sufficiently effective cooling. This entails a large consumption of energy in the fan device.

In another known cooling arrangement, flow paths are created in the form of cooling tubes of an electrically insulating material, usually a polymer material, which cooling tubes extend through the winding between the winding turns. A pumping device pumps a liquid, such as de-ionized water, through the tubes. However, such arrangements cooled by liquid exhibit the same drawbacks as the arrangements cooled by gas described above, as the flow paths increase the volume of the winding and reduce its capacity to withstand short-circuit forces. In addition, a further problem arises. The permeability to liquids, at least to a limited extent, of polymer materials poses a risk of the cooling liquid permeating through the cooling tube and into the insulating layer surrounding the lead in the cable. The cooling liquid, in combination with the electrical alternating field that arises around the lead when an alternating current runs through the same during operation, can form so-called water trees in the insulating layer. This is undesirable, as the formation of water trees weakens the electrical insulating strength of the insulating layer. The formation of water trees can also occur in the cooling tubes, which is not desirable either.

Another cooling arrangement is known through GB 2332557 A, which describes a power cable for high-voltage induction apparatus. The power cable comprises an inner support or cooling tube of metal, through which a coolant flows. The aim is to cool the power cable to cryostatic temperatures and the cooling tube in question consists of metal, for instance an alloy of copper and nickel.

A cable-wound induction machine with a cooling tube of conducting material wound with the cable displays a great disadvantage, however. The disadvantage is that the magnetic flux in the induction machine induces electric currents in the cooling tube. This results in the cooling tube being heated and undesired losses arising. This problem increases with the frequency and the rated output of the electric power system in which the induction machine operates.

### DESCRIPTION OF THE INVENTION

The object of the present invention is to provide a stationary induction machine with a new cooling device that completely or partially overcomes the above-mentioned drawbacks and problems.

The induction machine and the cable in accordance with the invention are characterized in that the cable includes a cooling tube of a polymer material that is arranged in the lead and forms said channel.

Efficient cooling is provided by the channel being arranged inside the lead in that the coolant acts in the immediate vicinity of the heat source, i.e. the lead of the cable. The excess heat does not have to permeate through the insulating layer of the cable before said heat can be displaced by the coolant. Furthermore, the coolant acts in the area where temperature peaks, so-called “hot spots”, normally occur in conventional cables, namely in the central part of the cable, which makes the cooling yet more efficient. Furthermore the channel, by being placed inside the lead, is not subjected to the electrical alternating field generated by the current in the lead. Thus, the problem involving the formation of water trees in the cooling tube is avoided. Besides, by the channel being placed inside the lead, adjoining winding turns can be placed in close proximity to each other, which enables a stable winding construction for good absorption of short-circuit forces.

Induced currents in the cooling tube are avoided by the cooling tube being of a polymer material. The losses in an induction machine in accordance with the invention are thereby considerably reduced, as compared with cable-wound induction machines where the cable has a cooling tube of a conducting material. In addition, as compared with metal, polymer materials are flexible, which provides an easily manipulated cable and consequent advantages in the formation of the winding.

### BRIEF DESCRIPTION OF THE DRAWINGS

The invention will be explained further in the following with reference to the drawings, where

FIG. 1 shows schematically a cable-wound reactor,

FIG. 2 shows a cut-away part of the cable that forms part of the reactor in accordance with FIG. 1, and

FIG. 3 shows an end part of the cable in accordance with FIG. 1.

### DESCRIPTION OF EMBODIMENTS

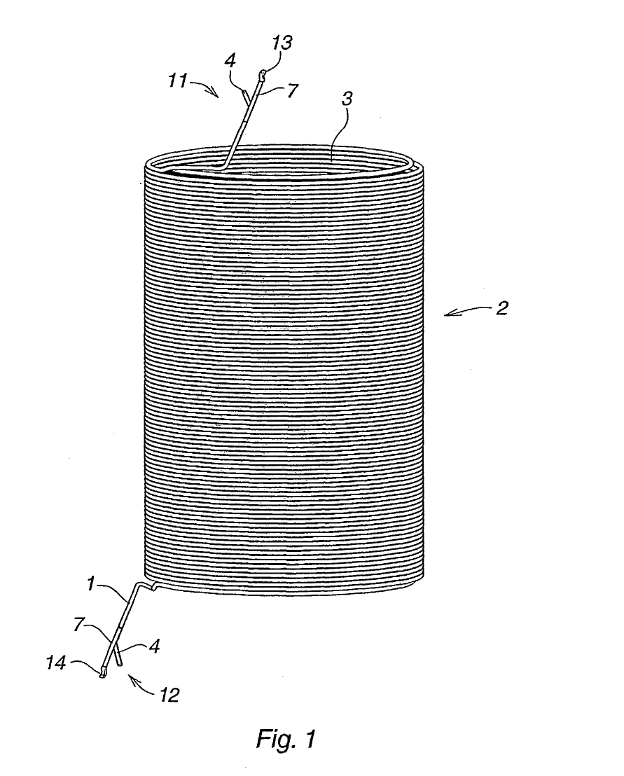

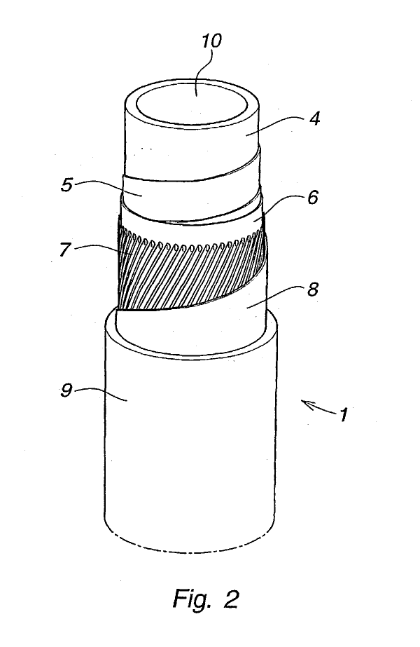

FIG. 1 shows parts of a cable-wound stationary induction machine in the form of a reactor. The reactor is intended for connection between converters in a HVDC system (not shown) and a phase conductor in a HVAC system (not shown) to dampen the harmonics generated by the converters. The reactor comprises a support structure, not shown, carrying a cable 1 wound so that it forms a cylindrical winding 2, surrounding a central part 3 filled with air, which forms the air core of the reactor. In this connection, the cable 1 is arranged to carry an electric current to generate a magnetic flow in the air core 3. A cut-away part of the cable is shown in FIG. 2. The cable has a substantially circular cross-section and comprises an elongate, flexible cooling tube 4 arranged concentrically about its longitudinal axis, a diffusion layer 5 surrounding the cooling tube 4, a semiconducting layer 6 surrounding the diffusion layer 5, a lead 7 surrounding the semiconducting layer 6, a support layer 8 surrounding the lead 7 and, finally, an insulating layer 9 surrounding the support layer 8. The cooling tube 4 forms a channel 10 occupying the central part of the cable 1, in which channel 10 a coolant in the form of a mixture of glycol and water flows. The cooling tube 4 is made of a polymer material, preferably cross-linked polythene (PEX). As polymer materials are permeable to liquids, at least to a limited extent, the diffusion layer 5 is arranged on the envelope surface of the tube to ensure that the glycol-water mixture does not permeate out into the outer parts of the cable 1 and cause the formation of water trees in the insulating layer 9. The diffusion layer 5 preferably consists of a polythene-laminated aluminium tape that is helically wound about the cooling tube 4, whereby a diffusion layer 5 is provided that is tight and in which only small electric currents are generated because of the magnetic flow in the air core 3 of the reactor. The semiconducting layer 6 arranged on the diffusion layer 5 consists of polythene mixed with pulverized coal, which forms the substructure for the lead 7 of the cable 1. The lead 7 is tubular. In the embodiment shown, it consists of a plurality of varnished aluminium wires disposed in close proximity to each other and wound in a layer on the semiconducting layer 6. The support layer 8 consists of a ribbon of polypropylene copolymer (PP copolymer), which is wound onto the lead 7 during manufacture of the cable 1 to prevent the polymer material of the insulating layer 9 from penetrating between the aluminium wires during the extrusion of the insulating layer 9 onto the cable 1. The insulating layer 9 preferably consists of PEX.

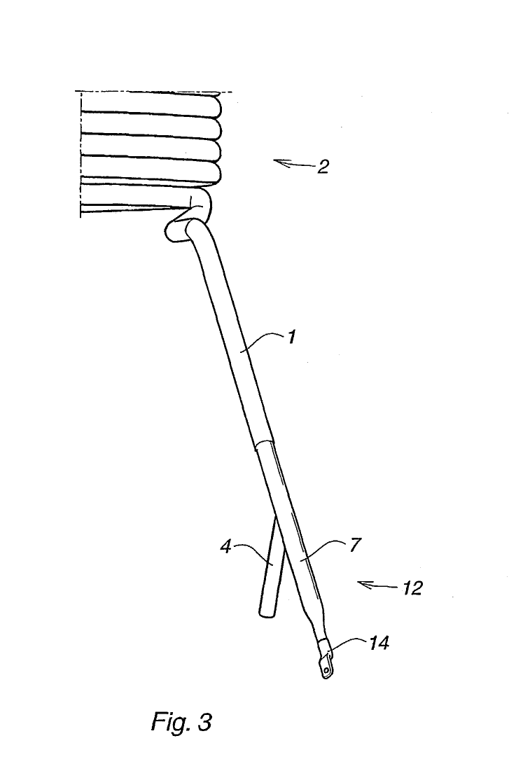

The cable extends between two end parts 11, 12, each respectively located at one of the two opposing end surfaces of the helical winding 2. One of the end parts is shown in FIG. 3. The insulating layer 9 and the support layer 8 are removed from the cable 1 at the end parts 11, 12. The cooling tube 4, at each end part 11, 12, exits through an opening in the semiconducting layer 6 and the lead 7, together with the diffusion layer 5, and, at each end part 11, 12, is coupled up to a connection tube (not shown), which leads the mixture of glycol and water to a pumping and heat-exchanger device (not shown). The lead 7, after being separated from the cooling tube 4 at each end part 11, 12, is electrically coupled up to a connection coupling 13, 14, which connection couplings 13, 14 are connected to the converters (not shown) of the HVDC system and one of the phase conductors (not shown) of the HVAC system respectively.

The principle of the invention has been described above in relation to a cable-wound single-phase reactor with an air core. However, it should be understood that the invention is also applicable to other types of cable-wound, stationary induction machines, for instance, a cable-wound three-phase power transformer with an iron core.

In the above embodiment, the coolant is a mixture of glycol and water. However, in other applications, other coolants can be used, such as de-ionized water or a gaseous coolant, such as air. In certain applications, the diffusion layer can be omitted. However, it is of great importance that the constituent parts of the cable are flexible to allow supple forming of the cable during manufacture of the induction machine.

1. A stationary induction machine including
at least one winding (2), including an elongate, flexible cable (1), having an electric lead (7), and
a cooling device, arranged, with the aid of a coolant, to divert excess heat generated in the lead (7) during operation of the induction machine,
where the lead (7) is in the form of a tube and surrounds a continuous channel (10) for the circulation of said coolant, characterized in that the cable (1) includes a cooling tube (4) of a polymer material that is arranged in the lead (7) and forms said channel (10).

2. An induction machine as claimed in claim 1, characterized in that the polymer material is cross-linked polythene.

3. An induction machine as claimed in claim 1 or 2, characterized in that a diffusion layer (5) impermeable to the coolant is arranged on the envelope surface of the cooling tube (4).

4. An induction machine as claimed in claim 3, characterized in that the diffusion layer (5) consists of polythene-laminated aluminium tape.

5. An induction machine as claimed in any one of claims 1-4, characterized in that the coolant is a mixture of glycol and water.

6. An induction machine as claimed in any one of claims 1-5, characterized in that the cable (1) includes a fixed electrically insulating layer (9) of a polymer material surrounding the lead (7).

7. An induction machine as claimed in any one of claims 1-6, characterized in that the channel (10) occupies the central part of the cable (1).

8. An elongate, flexible cable (1) including an electric lead (7) and a fixed electrically insulating layer (9) of a polymer material surrounding the lead (7), which cable (1) is intended to form a winding (2) in a stationary induction machine, in which a cooling device is arranged, with the aid of a coolant, to displace excess heat generated in the lead (7) during operation of the induction machine, which lead (7) is in the form of a tube and surrounds a continuous channel (10) for the circulation of said coolant, characterized in that the cable (1) includes a cooling tube (4) of a polymer material that is arranged in the lead (7) and forms said channel (10).

9. A cable as claimed in claim 8, characterized in that the polymer material is cross-linked polythene.

10. A cable as claimed in claim 8 or 9, characterized in that a diffusion layer (5) impermeable to the coolant is arranged on the envelope surface of the cooling tube (4).

11. A cable as claimed in any one of claims 8-10, characterized in that the channel (10) occupies the central part of the cable (1).
